(19) United States
(12) Patent Application Publication
(10) Pub. No.: US 2009/0097049 A1
(43) Pub. Date: Apr. 16, 2009

(54) IMAGE FORMING APPARATUS AND METHOD TO MANAGE FONT, FONT MANAGING DEVICE, AND FONT PROVIDING SERVER

(75) Inventor: Young-taek CHO, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/194,029

(22) Filed: Aug. 19, 2008

(30) Foreign Application Priority Data
Oct. 10, 2007 (KR) 2007-102029

(51) Int. Cl. G06F 15/00

(52) U.S. Cl. 358/1.11

(57) ABSTRACT

An image forming apparatus in as font managing system to manage a font, includes communication interface to download a file of a font having a use restriction, a storage unit to store the downloaded font file, the controller to determine whether the stored font file is usable if a document is requested to be printed with the font, and a print engine unit to print the document with the stored font if the stored font is usable.

### CROSS-REFERENCE TO RELATED APPLICATIONS

This application claims priority under 35 U.S.C. §119 (a) from Korean Patent Application No. 10-2007-102029, filed on Oct. 10, 2007, in the Korean Intellectual Property Office, the disclosure of which is incorporated herein by reference in its entirety.

### BACKGROUND OF THE INVENTION

1. Field of the Invention

The present general inventive concept relates to an image forming apparatus and a method to manage a font, a font managing device, and a font providing server, and more particularly, to an image forming apparatus to manage a font having a use restriction set selected by a user, a method to manage a font, a font managing device, and a font providing server.

2. Description of the Related Art

In general, an application program to write text has various fonts embedded therein such as GulimChe, BatangChe, and Gothic. The fonts embedded in the application program are installed in a user's computer at a same time of installing the application program, and a user selects a desired font and requests a document to be printed with the selected font.

Recently, as the user's demand is diversified, the user purchases and uses more various font files through the Internet. The font files purchased by the user are stored to the user's computer. If the user creates a document using the font file purchased through the computer and requests a printing, the computer converts the document into printing data which is printable, appends font data of the purchased font file to the converted printing data, and transmits the printing data to an image forming apparatus. The image forming apparatus prints the documents using the font data appended to the printing data.

However, the font file purchased by the user has no use restriction such as a number of usable times or a usable period, and the font file once purchased by the user can be used until the user deletes the font file. Accordingly, a cost to purchase the font file is higher than that of the font having a set use restriction. That is, even if a user wishes to use a font during a short period or for a few times, the user has to pay the same amount for the font and thus may feel that the font is sold at a relatively high price.

### SUMMARY OF THE INVENTION

The present general inventive concept provides an image forming apparatus a printing function by using a font having a use restriction, such as a number of usable times, a usable period, and an allowed user, and managing the font, a method thereof, a font managing device, and a font providing server.

Additional aspects and utilities of the present general inventive concept will be set forth in part in the description which follows and, in part, will be obvious from the description, or may be learned by practice of the general inventive concept

The foregoing and/or other aspects and utilities of the general inventive concept may be achieved by providing an image forming apparatus to provide to manage a font, the apparatus including a communication interface to receive a font having a use restriction, a storage unit to store the received font, a controller to determine whether the stored font is usable if a document is requested to be printed with the font, and a print engine unit to print the document with the stored font if the stored font is usable.

The restriction may include at least one of a number of usable times of the stored font, a usable period, and authentication information about a user who purchased the font.

The controller may determine that the font is usable if a remaining number of usable times has been stored to the storage unit or if a current date falls within the usable period.

The controller may count down from the number of usable times set for the font each time the stored font is used and store the counted-down number, and the restriction may be selectable by a user.

The foregoing and/or other aspects and utilities of the general inventive concept may also be achieved by providing a method to manage a font of an image forming apparatus, the method including receiving and storing a font having a use restriction, determining whether the stored font is usable if a document is requested to be printed with the font, and printing the document with the stored font if the stored font is usable.

The determining operation may determine that the font is usable if there is a stored remaining number of usable times or if a current date falls within the usable period.

The method may further include counting down from the set number of usable times each time the stored font is used and storing the counted-down number.

The foregoing and/or other aspects and utilities of the general inventive concept may also be achieved by providing a font managing device, the font managing device including a communication unit to download a font to an image forming apparatus if the font having a use restriction is purchased, an application program unit to set the purchased font as a font to use in printing a document, and a controller to transmits a name of the set font and the document to the image forming apparatus if the document is requested to be printed, and to control the communication unit to notify the image forming apparatus of whether the set font is usable.

The font managing device may further include a storage unit to store the restriction set for the font. If a request for approval for the use of the set font is received from the image forming apparatus, the controller may determine whether the set font is usable by checking the stored restriction, and if the set font is usable, the controller may transmit a message that a printing is allowed to the image forming apparatus, and if the set font is unusable, the controller may transmit a message that a printing should be stopped to the image forming apparatus.

The font managing device may further include a storage unit to store the restriction set for the font. The controller may determine whether the set font is usable by checking the stored restriction, and if the set font is usable, the controller may transmit the document and the set font to the image forming apparatus, and if the set font is unusable, the controller may notify a user that a printing operation is not allowed.

If a request to approve the use of the set font is received from the image forming apparatus, the controller may access a server which sold the font and determine whether the set font is usable, and if the set font is usable, the controller may transmit a message that a printing operation is allowed to the image forming apparatus, and if the set font is unusable, the controller may transmit a message that a printing operation should be stopped to the image forming apparatus.

The foregoing and/or other aspects and utilities of the general inventive concept may also be achieved by providing a font providing server, the font providing server including a font generator to generate a font based on a use restriction selected by a user, a server communication unit to transmit the generated font to an external device through which the user purchased the font, and a server controller to control the server communication unit to transmit the generated font to the external device if the user selected the use restriction and purchased the font.

The foregoing and/or other aspects and utilities of the general inventive concept may also be achieved by providing a font managing system including a managing program, an image forming apparatus having a storage unit, and to form an image, a font provider server to sell one or more fonts and to transmit a file of the respective font purchased, and a document processor to receive the transmitted file from the font provider server, to install a virtual font of the transmitted font file in the managing program and to download the purchased font file to the storage unit of the image forming apparatus.

The foregoing and/or other aspects and utilities of the general inventive concept may also be achieved by providing a method of a font managing system, the method including transmitting a file of the font purchased by a user from a font provider server, receiving the transmitted file from the font provider server, installing a virtual font of the transmitted font file in the managing program, and downloading the purchased font file to a storage unit of an image forming apparatus.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating an image forming apparatus which is capable of managing a font according to an exemplary embodiment of the present general inventive concept;

FIG. 2 is a diagram illustrating a file format of a purchased font;

FIG. 3 is a flowchart illustrating a method to manage a font of the image forming apparatus of FIG. 1;

FIG. 4 is a diagram illustrating a font managing device according to an exemplary embodiment of the present general inventive concept; and

FIG. 5 is a block diagram illustrating a font providing server according to an exemplary embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like units throughout. The embodiments are described below in order to explain the present general inventive concept by referring to the numerals.

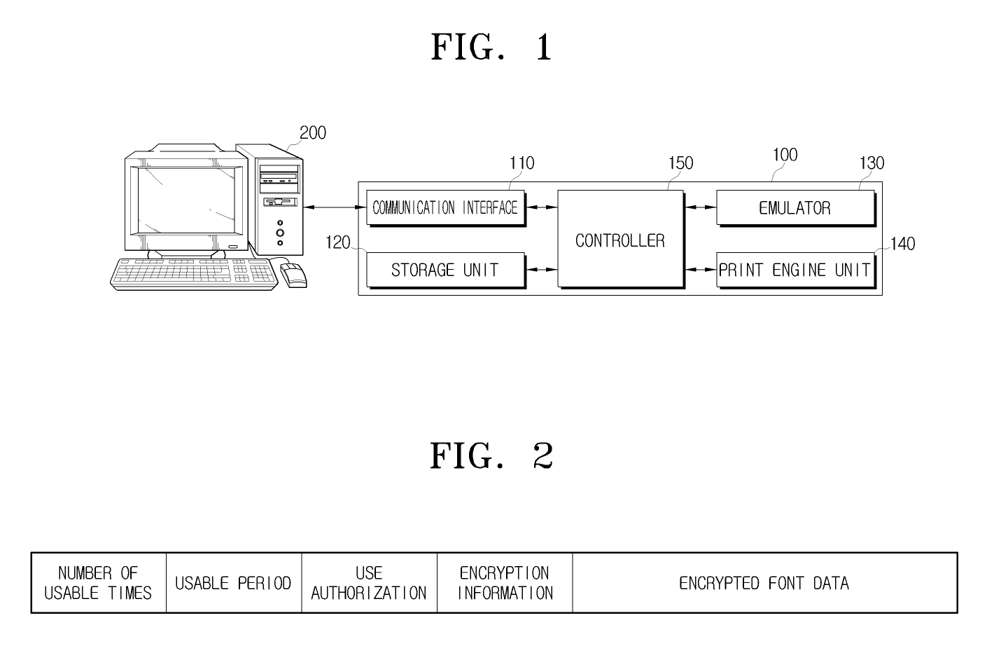

FIG. 1 is a block diagram illustrating an image forming apparatus to manage a font according to an exemplary embodiment of the present general inventive concept.

Referring to FIG. 1, an image forming apparatus 100 according to an exemplary embodiment of the present general inventive concept has a printing function, and for example, is a printer, a photocopier, a facsimile machine, or a multifunction peripheral. The image forming apparatus 100 provides functions of storing a font file to apply the font file in printing a document and printing a document transmitted from a document processor 200 using the pre-stored font file.

The document processor 200 provides functions of creating a document and allowing a user to access a font selling server (not illustrated) through a communication net and purchase a font the user wishes to have. For example, the document processor 200 is a user computer.

Recently, a font provider provides more various fonts to satisfy a diversified demand of the user. In this embodiment, the font provider provides a font having a restriction in a number of times of using the font, a usable period, or authentication information about the user who purchased the font in order to meet the user's demand. The number of usable time of the font or the usable period can be selected when the user purchase the font, after the user purchase the font, or during the use of the purchased font.

If the user selects and purchases a font, the font provider transmits a file of the purchased font to the document processor 200. The document processor 200 installs a virtual font of the transmitted font file in a managing system (e.g. Window), and downloads the purchased font file to the image forming apparatus 100. The virtual font is to make the user feel as if the purchased font file is stored in the document processor 200, and allows the user to use the purchased font on the document processor 200. This is because the purchased font is a resident type font stored and used in the image forming apparatus 100.

In order to print a document created by an application program of the document processor 200 using the purchased font, the user selects a font name of the purchased font, i.e., a name of the virtual font through a user interface (UI) provided by the application program. The selected font name is one of names of the virtual fonts installed in the managing system.

If the name of the virtual font is selected on the document, the document processor 200 displays a current number of useable times of the selected virtual font, the usable period, or information on the user who purchased the virtual font on an extra pop-up window, a UI of the application program, or a UI of a driver. For example, the driver of the image forming apparatus 100 installed in the document processor 200 requests the image forming apparatus 100 to transmit and receive use restriction information of the currently selected virtual font, and then displays the use restriction information.

The document processor 200 converts a document into printing data using the driver of the image forming apparatus 100, and appends the name of the virtual font to the converted printing data, and transmits the printing data to the image forming apparatus 100.

The image forming apparatus 100 includes a communication interface 110, a storage unit 120, an emulator 130, a print engine unit 140, and a controller 150.

The communication interface 110 transmits a file of the purchased font, which has been downloaded from the document processor 200, to the storage unit 120 under the control of the controller 150. Also, upon receiving the printing data of the document along with a printing request from the document processor 200, the communication interface 110 transmits the printing data to the emulator 130 through the controller 150.

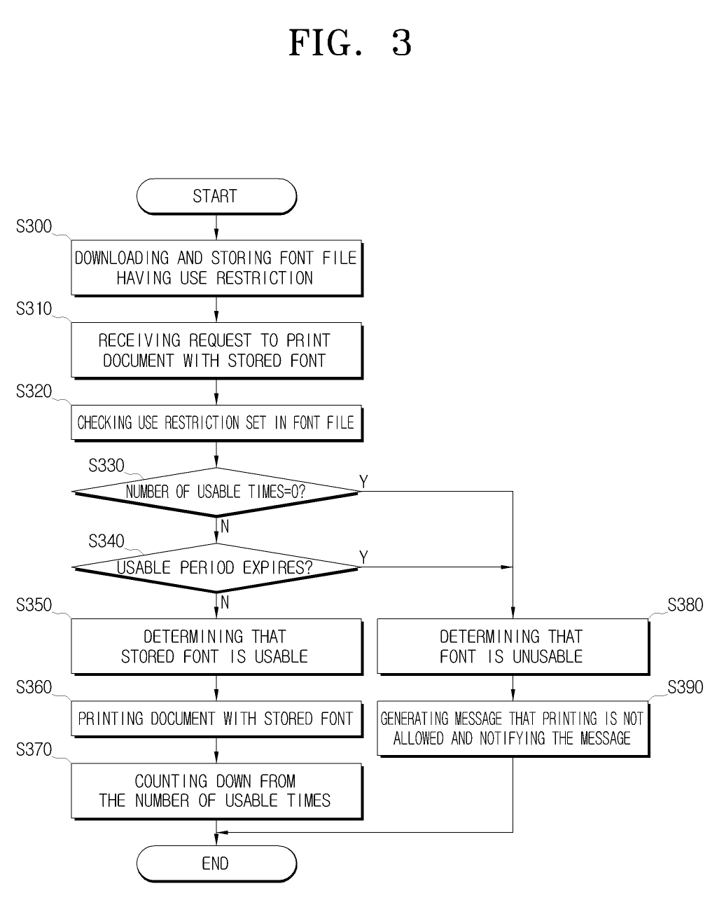

The storage unit 120 stores the file of the font having a use restriction. The stored file of the font may have a format illustrated in FIG. 2.

FIG. 2 is a diagram illustrating a file format of a purchased font. Referring to FIG. 2, the file of the purchased font includes information about the use restriction, encryption information, and encrypted font data. The use restriction information includes at least one of the number of usable times of the purchased font file, a usable period, and authentication information of allowed user.

The encryption information includes an encryption scheme and a decryption scheme of the font file, and the encrypted font data includes data that is required to print a text.

The emulator 130 checks the font name appended to the printing data if a request to print is input from the document processor 200. If the checked font name indicates a resident type font and also has a use restriction, i.e., if the font name indicates a font stored in the storage unit 120, the emulator 130 requests the controller 150 to permit the use of the font. The emulator 130 may determine that a use restriction is set if the checked font name is identical to the name of the purchased font which has been stored in the storage unit 120.

The controller 150 controls entire operations of the image forming apparatus 100 using pre-stored various control programs. The controller 150 determines whether the font appended to the printing data is usable. More specifically, the font appended to the printing data is a virtual font and a real font file has been stored in the storage unit 120. Accordingly, the controller 150 decrypts the font file stored in the storage unit 120, and then checks the use restriction which was set when the font file was purchased to determine whether the font is usable. The font file can be decrypted by performing a user authentication procedure. That is, the font file is decrypted if a user ID and a password input by the user are identical to the user ID and password used at the time of purchasing the font. If the font file is not encrypted, the decrypting operation will be omitted.

If the use restriction includes the number of usable times of the font, the controller 150 counts down from the number of usable time each time the font file is used and stores the counted-down number. Also, the controller 150 determines that the stored font file is usable if the number of usable time is not ‘0’, and determines that the stored font file is unusable if the number of usable time is ‘0’.

If the use restriction includes a usable period, the controller 150 checks a current date. If the current date falls within the usable period stored in the font file, the controller 150 determines that the stored font file is usable, and if the current date does not fall within the usable period, the controller 150 determines that the stored font file is unusable.

If a corresponding font is determined to be usable, the controller 150 decrypts the data of the font stored in the storage unit 120 according to a set decryption scheme and transmits the decrypted data to the emulator 130.

The emulator 130 emulates the printing data transmitted from the document processor 200, thereby generating a print language. For example, if the document is converted into the printing data in the document processor 200 in a printer control language (PCL) emulation mode, the emulator 130 emulates the printing data using the PCL. The emulator 130 generates a print language using the decrypted font data.

The print engine unit 140 prints the print language generated by the emulator 130 on paper.

As a printing operation is performed using the stored font data, the controller 150 counts down from the number of usable times stored in the storage unit 120 by ‘1’. After completing the printing operation, the controller 150 transmits to the document processor 200 a message indicating the remaining number of usable times, and the document processor 200 informs the user of the remaining number of usable times.

Alternatively, if a corresponding font is determined to be unusable, the controller 150 generates a message indicating that a printing is not allowed and transmits the message to the document processor 200 through the communication interface 110. The document processor 200 displays the respective message on a screen or outputs the message through a speaker so that the user can recognize this message.

FIG. 3 is a flowchart illustrating a method to manage a font of the image forming apparatus of FIG. 1.

Referring to FIGS. 1 to 3, the storage unit 120 stores a font file which has a use restriction and is downloaded from the document processor 200 (operation S300).

If a request for a printing operation of a document using the font stored in the storage unit 120 is received from the document processor 200 (operation S310), the controller 150 checks the use restriction set in the font file (operation S320). If a font name appended to printing data indicates a resident type font stored in the storage unit 120 in operation S310, the emulator 130 questions the controller 150 as to whether the corresponding font is usable.

If the number of usable times, which is set as the use restriction in the file of the corresponding font, is not ‘0’ (operation S330) and if a current date falls within a usable period (operation S340), the controller 150 determines that the corresponding font is usable (operation S350).

The controller 150 reads out data of the corresponding font from the storage unit 120 and decrypts the data, the emulator 130 emulates the decrypted font data and the printing data, and the print engine unit 140 prints the printing data using the font data (operation S360).

The controller 150 counts down from the number of usable times of the corresponding font stored in the storage unit 120 by ‘1’ since the corresponding font has been once used in operation S360 (operation S370).

Alternatively, if the number of usable times is ‘0’ in operation S330 or if the usable period expires in operation S340, the controller 150 determines that the corresponding font is unusable (operation S380).

Next, the controller 150 generates a message indicating that a printing is not allowed and transmits the message to the document processor 200 (operation S390).

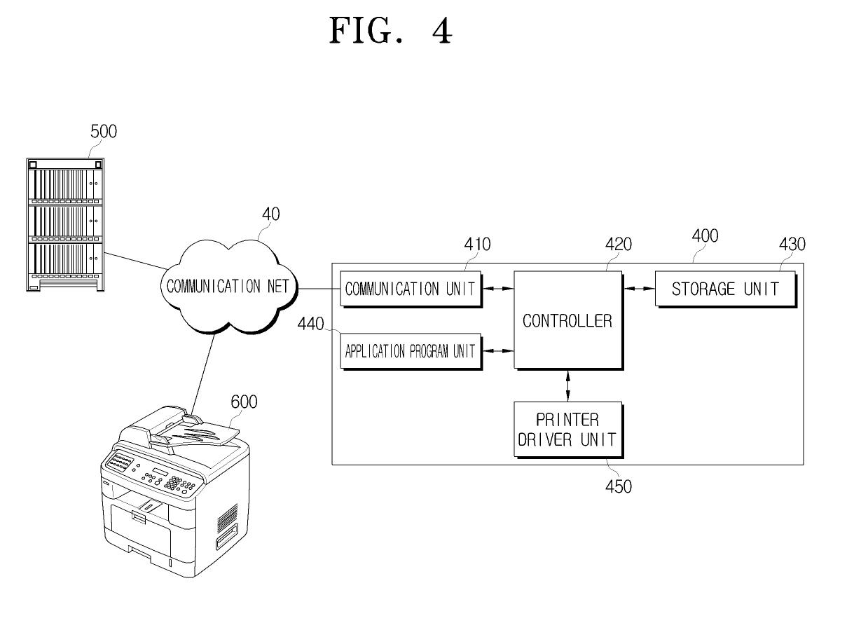

FIG. 4 is a diagram illustrating a font managing device according to an exemplary embodiment of the present general inventive concept.

Referring to FIG. 4, a font managing device 400 according to an exemplary embodiment of the present general inventive concept is communicably connected to a font server 500 and an image forming apparatus 600 through a communication net 40. The font server 500 is a server to sell a font the user wishes to purchase and allows the user to select a usable period of a font or the number of usable times of a font. The cost to purchase a font differs depending on the usable period or the number of usable times of the font selected by the user.

The image forming apparatus 600 may be a printer, a photocopier, a facsimile machine, or a multifunction peripheral, and provides a function of printing data transmitted from the font managing device 400.

The font managing device 400 includes a communication unit 410, a controller 420, a storage unit 430, an application program unit 440, and a printer driver unit 450.

The communication unit 410 downloads from the font server 500 a file of a font purchased by the user to the image forming apparatus 600. The purchased font is a resident type font a file of which is actually installed in the image forming apparatus 600, has a use restriction, and has an encrypted format including user authentication information. The file of the purchased font which is to be stored in the image forming apparatus 600 may have the format illustrated in FIG. 2 or may have a format having no encryption and use restriction information.

Upon receiving a file of the purchased font from the font server 500, the controller 420 installs a virtual font of the purchased font in an operating system and controls the communication unit 410 to transmit the received font file to the image forming apparatus 600. Also, if the image forming apparatus 600 questions the controller 420 as to whether the virtual font is usable, the controller 420 checks whether the font is usable and notifies the image forming apparatus 600 of the result of checking.

The storage unit 430 stores a font name of the purchased font i.e. of the virtual font and the use restriction of the purchased font.

The application program unit 440 supports an application program to create a document and provides a function of allocating a font to the created document. The application program unit 440 displays the font name of the purchased font file through a UI provided by the application program unit 440 so that the user can select the purchased font from the plurality of font names displayed on the UI. If the user sets the font to use in printing the document as the resident type virtual font purchased from the font server 500, the controller 420 checks whether the virtual font is usable.

The controller 420 checks the use restriction of the virtual font stored in the storage unit 430. If the number of usable times is not ‘0’ and if a usable period does not expire, the controller 420 determines that the set virtual font is usable. The use restriction may include any one of the number of usable times and the usable period.

If the virtual font is usable, the printer driver unit 450 converts the document to printing data using a specific emulation mode and appends the name of the set virtual font to the converted printing data.

The communication unit 410 transmits the printing data including the name of the virtual font to the image forming apparatus 600 along with a request for a printing operation of the document.

If the image forming apparatus 600 is requested from the font managing device 400 to print the document, the image forming apparatus 600 emulates the printing data using font data corresponding to the virtual font appended in the printing data and prints the printing data on paper. As described above, the font data of the virtual font has been already downloaded from the font managing device 400 and installed on the image forming apparatus 600.

If the controller 420 determines that the virtual font is unusable, the controller 420 generates a message indicating that the printing is not allowed and provides the message to the user. Also, if the document is printed using the purchased font, the controller 420 upgrades the use restriction stored in the storage unit 430. For example, if the use restriction includes the number of usable times, the controller 420 counts down from the number of usable times by ‘1’.

The font managing device 400 described with reference to FIG. 4 determines whether the purchased font i.e. the virtual font is usable prior to transmitting the printing data to the image forming apparatus 600.

However, the font managing device 400 may determine whether the virtual font is usable after transmitting the printing data to the image forming apparatus 600 on the request from the image forming apparatus 600.

For example, if the image forming apparatus 600 receives printing data from the font managing device 400 along with a request for a printing operation, the image forming apparatus 600 checks whether a font appended to the printing data is the virtual font. That is, if the name of the font appended to the printing data is identical to a name of a font that has been previously purchased and downloaded from the font managing device 400, the image forming apparatus 600 determines that the font is a virtual font. Then, the image forming apparatus 600 requests the font managing device 400 to check whether the virtual font i.e. the purchased font is usable.

The controller 420 of the font managing device 400 checks the use restriction of the virtual font stored in the storage unit 430 on the request from the image forming apparatus 600 and determines whether the virtual font is usable. The criterion of determining whether the virtual font is usable is as described above. If the font is determined to be usable, the controller 420 transmits a message indicating that the font is usable to the image forming apparatus 600 through the interface 410, and if the font is determined to be unusable, the controller 420 transmits a message to stop the printing operation to the image forming apparatus 600.

As an another example, if the image forming apparatus 600 requests the font managing device 400 to check whether the purchased font is usable, the controller 420 accesses the font server 500 to check whether the purchased font is usable. The controller 420 reads out authentication information of the user who purchased the font and the name of the purchased font from the storage unit 430 and transmits the readout information to the font server 500. The font server 500 checks the use restriction of the font mapped into the authentication information of the user and determines whether the font is usable. The font server 500 transmits a result of determining whether the font is usable to the font managing device 400. The controller 420 of the font managing device 400 transmits to the image forming apparatus 600 a message indicating that the font is usable or that a printing operation should be stopped based on the result of determination.

Also, the image forming apparatus 600 may directly question the font server 500 as to whether the purchased font is usable.

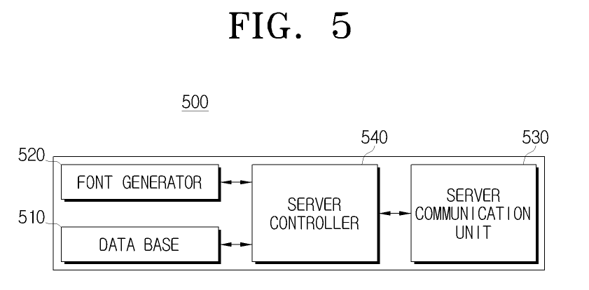

FIG. 5 is a block diagram illustrating a font providing server according to an exemplary embodiment of the present general inventive concept. A font providing server 500 according to an exemplary embodiment of the present general inventive concept is a server to sell various fonts to provide a diverse selection to the user and allows the user to set the number of usable times of a font or a usable period.

For this, the font providing server 500 includes a data base 510, a font generator 520, a server communication unit 530, and a server controller 540. The data base 510 stores images of the various fonts the font providing server 500 provides, maps information of a font purchased by the user, such as a font name, use restriction, purchasing cost, into the authentication information of the user, and stores the mapped information. The user authentication information is used in decrypting the font file in the image forming apparatus 100, the document processor 200, or the font managing device 400.

The font generator 520 generates a font file based on a use restriction of a font and an encryption scheme which are selected by the user. For example, if the user selects the “number of usable times=3” as the use restriction of the font and if the user selects one of a plurality of encryption schemes, the font generator 520 generates a file format including a section indicating the “number of usable times=3”, the selected encryption scheme and encrypted data, and also selectively including the user authentication information. The usable period is not included in the file.

The server controller 540 transmits the file of the font purchased by the user to the document processor 200 of FIG. 1 or the font managing device 400 of FIG. 4 through the server communication unit 530. Also, if the font managing device 400 or the image forming apparatus 600 questions as to whether the font is usable, the server controller 540 checks the use restriction information stored in the data base 510 and determines whether the font is usable. For example, if the number of usable times of the font ‘B’ purchased by the user ‘A’ is set to ‘1’ and if the current date falls within a usable period, the server controller 540 determines that the font is usable and notifies the font managing device 400 or the image forming apparatus 600 of the result of determination.

The font providing server 500 described above may be the font provider mentioned in the description made with reference to FIG. 1 or the font server mentioned in the description made with reference to FIG. 4. The font providing server 500 generates a font file using an encryption scheme selected by the user or generates font files to have different font data structures, thereby preventing the font once purchased by the user from being copied and spreading and easily managing the copyright of the font. Also, the prices are differently set depending on the use restriction or the encryption scheme selected by the user so that the expense paid by the user can be minimized or the user demand can be easily satisfied.

Also, according to the exemplary embodiments of the present general inventive concept, the number of usable times is counted down after the printing operation. However, this should not be considered as limiting. For example, if the purchased font can be used up to 500 times, the number of usable times is counted by +1 each time the purchased font is used, and then if the number of usable times is counted up to 500, a determination is made that the font cannot be used any longer.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Also, according to various embodiments of the present general inventive concept, a user can adjust a number of usable times or the usable period when purchasing a font and print a document using the purchased font. Accordingly, reducing a cost to purchase the font and provide more various fonts.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus to manage a font, the apparatus comprising:
a communication interface to receive a font having a use restriction;
a storage unit to store the received font;
a controller to determine whether the stored font is usable if a document is requested to be printed with the font; and
a print engine unit to print the document with the stored font if the stored font is usable.

2. The image forming apparatus as claimed in claim 1, wherein the restriction includes at least one of a number of usable times of the stored font, a usable period, and authentication information about a user who purchased the font.

3. The image forming apparatus as claimed in claim 2, wherein the controller determines that the font is usable if a remaining number of usable times has been stored to the storage unit or if a current date falls within the usable period.

4. The image forming apparatus as claimed in claim 2, wherein the controller counts down from the number of usable times set for the font each time the stored font is used and stores the counted-down number.

5. The image forming apparatus as claimed in claim 2, wherein the restriction is selectable by a user.

6. A method to manage a font of an image forming apparatus, the method comprising:
receiving and storing a font having a use restriction;
determining whether the stored font is usable if a document is requested to be printed with the font; and
printing the document with the stored font if the stored font is usable.

7. The method as claimed in claim 6, wherein the restriction includes at least one of a number of usable times of the stored font, a usable period, and authentication information of a user who purchased the font.

8. The method as claimed in claim 7, wherein the determining operation determines that the font is usable if there is a stored remaining number of usable times or if a current date falls within the usable period.

9. The method as claimed in claim 6, further comprising:
counting down from the set number of usable times each time the stored font is used and storing the counted-down number.

10. The method as claimed in claim 7, wherein the restriction is selectable by a user.

11. A font managing device, the font managing device comprising:
a communication unit to download a font to an image forming apparatus if the font having a use restriction is purchased;
an application program unit to set the purchased font as a font to use in printing a document; and
a controller to transmit a name of the set font and the document to the image forming apparatus if the document is requested to be printed, and to control the communication unit to notify the image forming apparatus of whether the set font is usable.

12. The font managing device as claimed in claim 11, further comprising:
a storage unit to store the restriction set for the font,
wherein, if a request for approval for the use of the set font is received from the image forming apparatus, the controller determines if the set font is usable by checking the stored restriction, and if the set font is usable, the controller transmits a message that a printing is allowed to the image forming apparatus, and if the set font is unusable, the controller transmits a message that a printing should be stopped to the image forming apparatus.

13. The font managing device as claimed in claim 11, further comprising:
a storage unit to store the restriction set for the font,
wherein the controller determines whether the set font is usable by checking the stored restriction, and if the set font is usable, the controller transmits the document and the set font to the image forming apparatus, and if the set font is unusable, the controller notifies a user that a printing operation is not allowed.

14. The font managing device as claimed in claim 11, wherein, if a request to approve the use of the set font is received from the image forming apparatus, the controller accesses a server which sold the font and determines whether the set font is usable, and if the set font is usable, the controller transmits a message that a printing operation is allowed to the image forming apparatus, and if the set font is unusable, the controller transmits a message that a printing operation should be stopped to the image forming apparatus.

15. The font managing device as claimed in claim 11, wherein the restriction includes at least one of a number of usable times, a usable period, and authentication information of a user who purchased the font.

16. A font providing server, the font providing server comprising:
a font generator to generate a font based on a use restriction selected by a user;
a server communication unit to transmit the generated font to an external device through which the user purchased the font; and
a server controller to control the server communication unit to transmit the generated font to the external device if the user selected the use restriction and purchased the font.

17. The font providing server as claimed in claim 16, wherein the use restriction includes at least one of a number of usable times of the font and a usable period.

18. A font managing system, comprising:
a managing program;
an image forming apparatus having a storage unit, and to form an image;
a font provider server to sell one or more fonts and to transmit a file of the respective font purchased; and
a document processor to receive the transmitted file from the font provider server, to install a virtual font of the transmitted font file in the managing program and to download the purchased font file to the storage unit of the image forming apparatus.

19. A method of a font managing system, the method comprising:
transmitting a file of the font purchased by a user from a font provider server;
receiving the transmitted file from the font provider server;
installing a virtual font of the transmitted font file in the managing program; and
downloading the purchased font file to a storage unit of an image forming apparatus.
